(19) United States
(12) Patent Application Publication
(10) Pub. No.: US 2026/0121333 A1
(43) Pub. Date: Apr. 30, 2026

(54) Plug Assembly and Connector Assembly Including the Same

(71) Applicant: Tyco Electronics AMP Korea Co., Ltd., Gyeongsan (KR)

(72) Inventors: Min Jae Kwon, Gyeongsan-Si (KR); Gi-Chan Kwon, Gyeongsan-Si (KR); Si Yun Song, Gyeongsan-si (KR)

(73) Assignee: Tyco Electronics AMP Korea Co., Ltd., Gyeongsan (KR)

(21) Appl. No.: 19/373,964

(22) Filed: Oct. 30, 2025

(30) Foreign Application Priority Data
Oct. 31, 2024 (KR) 10-2024-0152537
Apr. 15, 2025 (KR) 10-2025-0048717
Jul. 24, 2025 (KR) 10-2025-0100900

(51) Int. Cl. H01R 13/502; H01R 13/424

(52) U.S. Cl. CPC H01R 13/502; H01R 13/424

(57) ABSTRACT

A plug assembly includes a plug housing and a bus terminal. The plug housing includes a plug body having a plurality of first direction partition walls longitudinally formed in a first direction, a plurality of second direction partition walls formed in a second direction that intersects with the first direction, a plurality of terminal holes defined by the plurality of first direction partition walls and the plurality of second direction partition walls, and a seating space allowing a pair of terminal holes of the plurality of terminal holes that are adjacent in the first direction to communicate with each other. The bus terminal includes a terminal body inserted into the seating space and a pair of contact arms extending from the terminal body and each protruding into one of the pair of terminal holes. The plug assembly is inserted into a header assembly of a target device.

### CROSS-REFERENCE TO RELATED APPLICATIONS

This application claims the benefit of the filing date under 35 U.S.C. § 119 (a)-(d) of Korean Patent Application No. 10-2024-0152537, filed on Oct. 31, 2024, Korean Patent Application No. 10-2025-0048717, filed on Apr. 15, 2025, and Korean Patent Application No. 10-2025-0100900, filed on Jul. 24, 2025.

### FIELD OF THE INVENTION

The present invention relates to a plug assembly and, more particularly, to a plug assembly and a connector assembly including the plug assembly.

### BACKGROUND OF THE INVENTION

A connector is a type of electronic component that allows or blocks an electrical connection. Connectors are used in various electromechanical devices, such as automobiles or home appliances, to enable an electrical and/or physical connection between a plurality of electronic components.

A connector enables a connection among electronic components through simple operations, for example, insertion by pressing in a direction, and/or by rotating or sliding a lever. Accordingly, since manual wiring work, which previously required workers to strip and connect wires, may be significantly reduced, connectors are actively used, for example, to connect numerous electronic components, such as in a vehicle.

The above description is information the inventor(s) acquired during the course of conceiving the present disclosure, or already possessed at the time, and is not necessarily art publicly not known before the present application was filed.

### SUMMARY OF THE INVENTION

A plug assembly includes a plug housing and a bus terminal. The plug housing includes a plug body having a plurality of first direction partition walls longitudinally formed in a first direction, a plurality of second direction partition walls formed in a second direction that intersects with the first direction, a plurality of terminal holes defined by the plurality of first direction partition walls and the plurality of second direction partition walls, and a seating space allowing a pair of terminal holes of the plurality of terminal holes that are adjacent in the first direction to communicate with each other. The bus terminal includes a terminal body inserted into the seating space and a pair of contact arms extending from the terminal body and each protruding into one of the pair of terminal holes. The plug assembly is inserted into a header assembly of a target device.

### BRIEF DESCRIPTION OF DRAWINGS

The invention will now be described by way of example with reference to the accompanying figures, of which:

FIG. 1 is a perspective view of a plurality of connector assemblies installed in a plurality of target devices, respectively, according to an embodiment;

FIG. 2 is a diagram illustrating a view in which a signal or a power is sequentially transmitted when the plurality of connector assemblies of FIG. 1 are properly installed in the plurality of target devices of FIG. 1;

FIG. 3 is a diagram illustrating a view in which a signal or a power is sequentially transmitted when a portion of the plurality of connector assemblies of FIG. 1 are not properly installed in the target device of FIG. 1;

FIG. 4 is a diagram illustrating a view in which a signal or a power is sequentially transmitted when a portion of a plurality of connector assemblies is not properly installed in a target device according to another embodiment;

FIG. 5 is a perspective view of a plug assembly according to an embodiment;

FIG. 6 is a partial exploded perspective view of the plug assembly of FIG. 5, where a plug cover is separated from the plug assembly;

FIG. 7 is an exploded perspective view of the plug assembly of FIG. 5, where the cover of FIG. 6 and a bus terminal are separated from the plug assembly;

FIG. 8 is a perspective view of the bus terminal of FIG. 7;

FIG. 9 is a cross-sectional perspective view of a state in which a cable terminal is inserted into the plug assembly of FIG. 5;

FIG. 10 is a cross-sectional side view of when a connector assembly is installed in a target device according to an embodiment;

FIG. 11 is a diagram illustrating a wiring configuration of a plug assembly and a header assembly according to another embodiment;

FIG. 12 is a cross-sectional side view of when a connector assembly is installed in a target device according to another embodiment;

FIG. 13 is a diagram illustrating a wiring configuration of a plug assembly and a header assembly according to another embodiment;

FIG. 14 is a perspective view of a bus terminal according to another embodiment;

FIG. 15 is a cross-sectional view of a state in which a cable assembly is inserted into a plug assembly according to another embodiment; and

FIG. 16 is a perspective view of a plug assembly according to another embodiment.

### DETAILED DESCRIPTION

Hereinafter, embodiments are described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not intended to limit the embodiments. As used herein, the singular form is intended to include the plural forms as well, unless the context clearly indicates otherwise. It should be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof.

Unless otherwise defined, all terms including technical and scientific terms used herein have the same meaning as commonly understood by one of ordinary skill in the art to which embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like constituent elements and a repeated description related thereto will be omitted. In the description of embodiments, detailed description of well-known related technology will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one constituent element from another constituent element, and the nature, the sequences, or the orders of the constituent elements are not limited by the terms. It should be noted that if one component is described as being “connected,” “coupled” or “joined” to another component, the former may be directly “connected,” “coupled,” and “joined” to the latter or “connected”, “coupled”, and “joined” to the latter via another component.

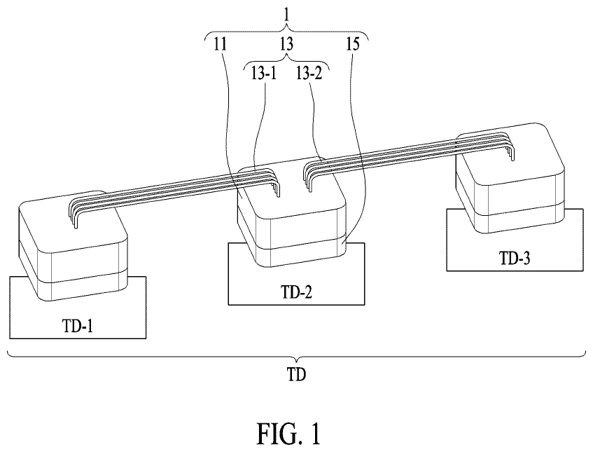

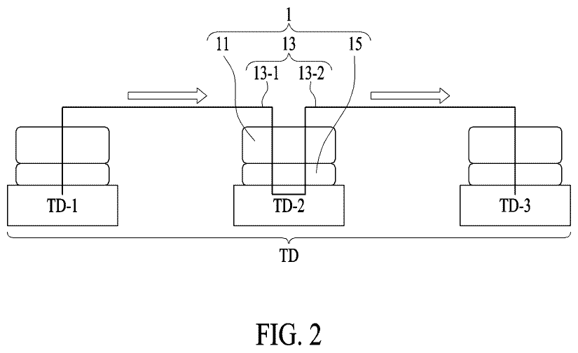

An exemplary embodiment of a connector assembly 1 will now be described with reference to FIGS. 1-3. As shown in FIGS. 1-3, a plurality of connector assemblies 1 according to an embodiment may be installed in a plurality of target devices TD, respectively, to transmit a signal to the plurality of target devices TD. The plurality of target devices TD may include a first device TD-1, a second device TD-2, and a third device TD-3. For example, a signal transmitted to the first device TD-1 may be transmitted to the third device TD-3 via the second device TD-2. Based on this signal flow, the first device TD-1, the second device TD-2, and the third device TD-3 may be referred to as a start node, an intermediate node, and an end node, respectively. For example, a plurality of intermediate nodes may be provided. The connector assembly 1 according to an embodiment may be installed in the second device TD-2 (e.g., the intermediate node), but is not limited thereto. For example, each of the target devices TD may be a plurality of electronic components (e.g., a front camera, a rear camera, and a side mirror) included in a product (e.g., a vehicle). For example, as an arrow shown in FIG. 2, each of the target devices TD may sequentially transmit a signal. By using the structure described above, since a signal is transmitted from the first device TD-1 to the third device TD-3 without a cable assembly 23 that directly connects the first device TD-1 to the third device TD-3, the ease or wiring work of a product may be improved and the complexity of wiring may be reduced.

As shown in FIGS. 1-3, the connector assembly 1 may include a plug assembly 11, a cable assembly 13, and a header assembly 15. The plug assembly 11 may be detachably coupled to the header assembly 15. The header assembly 15 may be installed in the target device TD (e.g., the second device TD-2) and may transmit a signal from the outside (e.g., the first device TD-1) to the target device TD via a first cable assembly 13-1 coupled to the plug assembly 11 or from the target device TD to the outside (e.g., the third device TD-3) via a second cable assembly 13-2 coupled to the plug assembly 11.

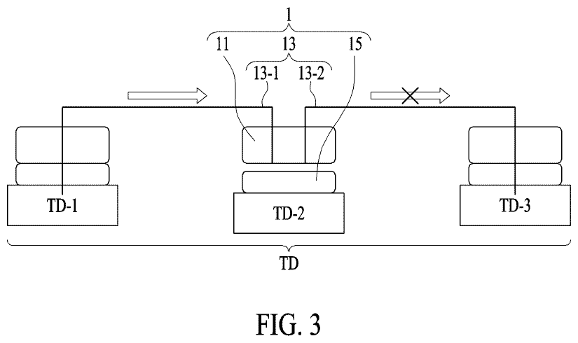

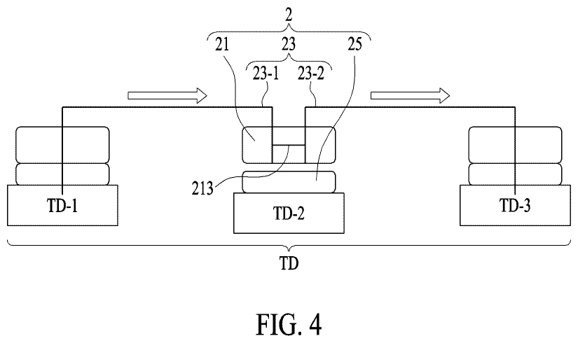

Meanwhile, as described above, to transmit a signal from the first device TD-1 to the third device TD-3, the second device TD-2 may include an internal circuit that transmits a signal input from the first cable assembly 13-1 to the second cable assembly 13-2. However, as shown in FIG. 3, when the plug assembly 11 is not properly connected to the header assembly 15, a path of an electrical signal transmitted from the second device TD-2 to the third device TD-3 may be open, and accordingly, the electrical signal may not be transmitted from the first device TD-1 to the third device TD-3. Accordingly, even if peripheral components (e.g., a connector assembly) of the first and third devices TD-1 and TD-3 are properly coupled, a signal may not be properly transmitted to other devices due to poor assembly of the connector assembly 1 installed in some devices (e.g., the second device TD-2). Meanwhile, according to an embodiment described below with reference to FIGS. 4-11, this problem may be reduced.

An embodiment of a connector assembly 2 will now be described with reference to FIGS. 4-9. As shown in FIG. 4, the connector assembly 2 according to an embodiment may include a plug assembly 21, a cable assembly 23, and a header assembly 25. The cable assembly 23 may include a first cable assembly 23-1 and a second cable assembly 23-2.

The plug assembly 21 according to an embodiment may include a bus terminal 213, as shown in FIGS. 4 and 6-9, that electrically connects the first cable assembly 23-1 to the second cable assembly 23-2. As shown in FIG. 4, even if the plug assembly 21 is not properly connected to the header assembly 25, a signal transmitted from the first device TD-1 may be transmitted to the third device TD-3 by bypassing the second device TD-2 with the bus terminal 213. Accordingly, the problem described with reference to the embodiment shown in FIGS. 1-3 may be reduced.

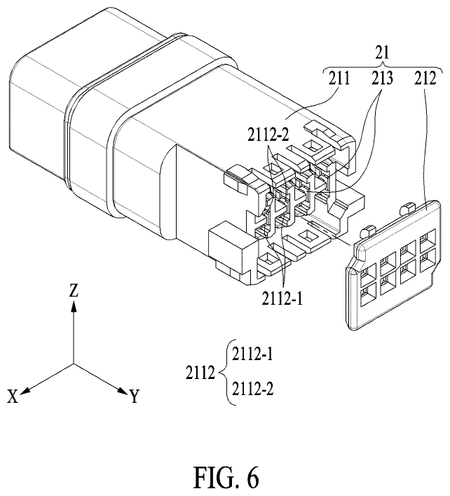

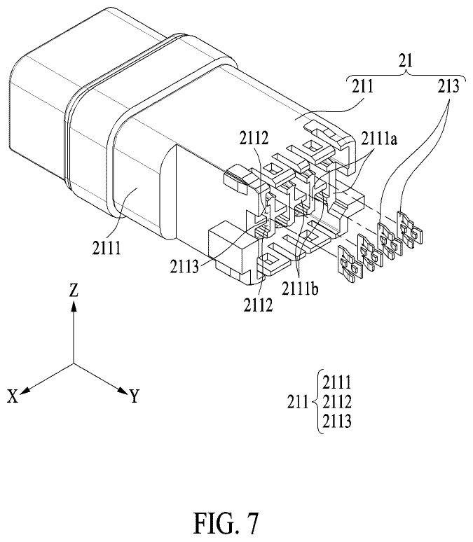

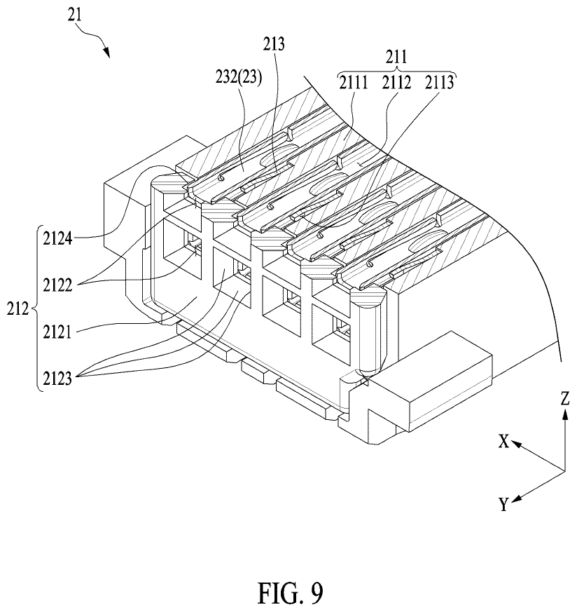

As shown in FIG. 6, the plug assembly 21 according to an embodiment may include a plug housing 211, a plug cover 212, and the bus terminal 213. The plug housing 211 may be inserted into the header assembly 25 of the target device TD. As shown in FIGS. 7 and 9, the plug housing 211 may include a plug body 2111, a terminal hole 2112, and a seating space 2113.

The plug body 2111 may form the exterior of the plug housing 211. As shown in FIG. 7, the plug body 2111 may include a plurality of first direction partition walls 2111a longitudinally formed in a first direction (e.g., the Z direction) and a plurality of second direction partition walls 2111b formed in a second direction (e.g., the X direction) intersecting with the first direction. For example, the second direction partition wall 2111b may be formed in a direction perpendicular to the first direction partition wall 2111a, but is not limited thereto.

As shown in FIGS. 7 and 9, the terminal hole 2112 may be formed to penetrate the plug body 2111. The cable assembly 23 may be inserted into the terminal hole 2112. The terminal hole 2112 may be longitudinally formed in an insertion direction (e.g., the Y direction) in which the plug assembly 21 is inserted into the header assembly 25. It may be understood that a plurality of terminal holes 2112 is defined by the plurality of first direction partition walls 2111a and the plurality of second direction partition walls 2111b described above. For example, the shape of the plurality of terminal holes 2112 may be the same, but the example is not limited thereto.

As shown in FIG. 6, the plurality of terminal holes 2112 may include a plurality of first terminal holes 2112-1 arranged along a first row that is parallel to the second direction (e.g., the X direction) and a plurality of second terminal holes 2112-2 arranged along a second row that is parallel to the second direction and is spaced apart from the first row in the first direction (e.g., the Z direction). For example, the number of first terminal holes 2112-1 or the number of second terminal holes 2112-2 may be an even number greater than or equal to 4, but the example is not limited thereto.

The bus terminal 213 may be mounted on the seating space 2113. The seating space 2113, as shown in FIGS. 7 and 9, may allow a pair of terminal holes 2112 adjacent to each other in the first direction (e.g., the Z direction) among the plurality of terminal holes 2112 to communicate with each other. This structure may enable both sides of the bus terminal 213 to be physically in contact with the pair of adjacent cable assemblies 23 to electrically connect the pair of cable assemblies 23 to each other.

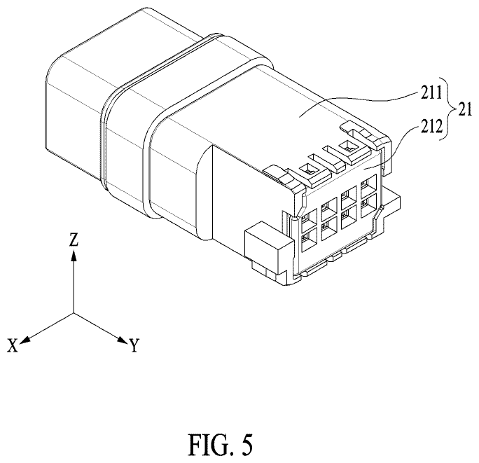

As shown in FIG. 5, the plug cover 212 may be installed on a side of the plug housing 211. A detailed structure of the plug cover 212 is described below with reference to the drawings.

The bus terminal 213 may electrically connect to each other the pair of cable assemblies 23 that are adjacent to the bus terminal 213. The bus terminal 213 may be installed in the seating space 2113. For example, the plug assembly 21 may include a plurality of bus terminals 213, and each of the plurality of bus terminals 213 may be installed between each of the plurality of first terminal holes 2112-1 and each of the plurality of second terminal holes 2112-2. In other words, the bus terminal 213 may be installed between the first terminal hole 2112-1 and the second terminal hole 2112-2 that overlap each other in the first direction (e.g., the Z direction), thereby electrically connecting a terminal of the cable assembly 23 installed in the first terminal hole 2112-1 to a terminal of the cable assembly 23 installed in the second terminal hole 2112-2. A detailed structure of the bus terminal 213 is described below with reference to the drawings.

As shown in FIG. 6, the plug assembly 21 according to an embodiment may include the plug cover 212, the bus terminal 213, and the plug housing 211 including the plug body 2111, the terminal hole 2112, and the seating space 2113.

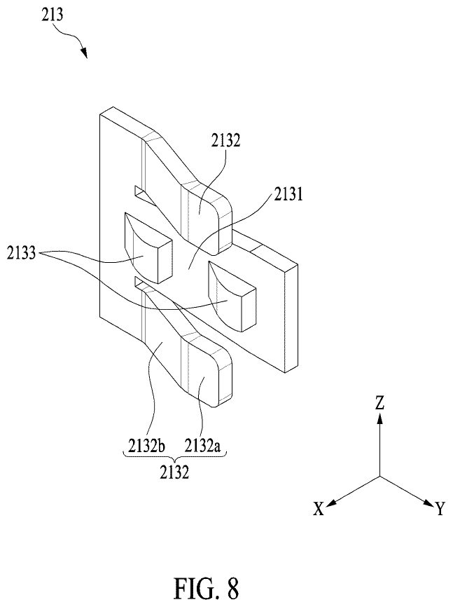

The bus terminal 213 according to an embodiment may include a terminal body 2131, as shown in FIG. 8, inserted into the seating space 2113, a contact arm 2132, as shown in FIG. 8, and a fixing protrusion 2133, as shown in FIG. 8. The contact arm 2132 may extend from the terminal body 2131 and may protrude to the terminal hole 2112. For example, the bus terminal 213 may include a pair of contact arms 2132. The pair of contact arms 2132 may extend from the terminal body 2131 and may protrude to a pair of terminal holes 2112, respectively.

For example, the contact arm 2132 and the terminal body 2131 may be formed of a single plate including a conductive material (e.g., metal). Continuing with the example, the contact arm 2132 may be formed by cutting and bending a portion of the plate described above, but the example is not limited thereto.

As shown in FIG. 8, the contact arm 2132 may include an arm contact portion 2132a and an arm extension 2132b. The arm contact portion 2132a may contact the cable assembly 23 inserted into the terminal hole 2112. The arm contact portion 2132a may be understood as a portion that supports the cable assembly 23 as the arm contact portion 2132a is substantially in contact with the cable assembly 23 (e.g., a cable terminal 232). The arm extension 2132b may connect the terminal body 2131 to the arm contact portion 2132a. The arm extension 2132b may be inclined in a direction away from the first direction partition wall 2111a that is closest to the terminal body 2131 among the plurality of first direction partition walls 2111a. For example, the arm extension 2132b may be inclined in a direction (in other words, a direction into the center of the terminal hole 2112) away from the terminal body 2131 toward a direction (e.g., the Y direction) in which the cable assembly 23 is inserted into the terminal hole 2112. The shape described above may reduce a problem that the cable assembly 23 may not properly enter the terminal hole 2112 because the cable assembly 23 interferes with the bus terminal 213 while inserting the cable assembly 23 into the terminal hole 2112.

As shown in FIG. 8, the fixing protrusion 2133 may protrude from the terminal body 2131. The fixing protrusion 2133 may be fixed to the second direction partition wall 2111b between a pair of terminal holes 2112 in the first direction (e.g., the Z direction) connected by the bus terminal 213 among the plurality of second direction partition walls 2111b. For example, the fixing protrusion 2133 may have a height that is greater than the distance (in other words, the height of the seating space 2113) between the second direction partition wall 2111b and the first direction partition wall 2111a. This structure may enable the bus terminal 213 to be fixed to the seating space 2113. For example, a plurality (e.g., two) of fixing protrusions 2133 may be spaced apart in the longitudinal direction (e.g., the Y direction) of the terminal hole 2112. According to the configuration described above, even if the fixing protrusion 2133 has a circular shape, it may help the bus terminal 213 be in a stably fixed state with respect to the seating space 2113 without being twisted. For example, the fixing protrusion 2133 may protrude by pressing a specific point of the terminal body 2131, but the example is not limited thereto.

As shown in FIG. 9, the plug cover 212 according to an embodiment may include a cover body 2121, a guide hole 2122, a hole chamfer 2123, and a guide step 2124. In an embodiment, the plug cover 212 has a plurality of hole chamfers 2123.

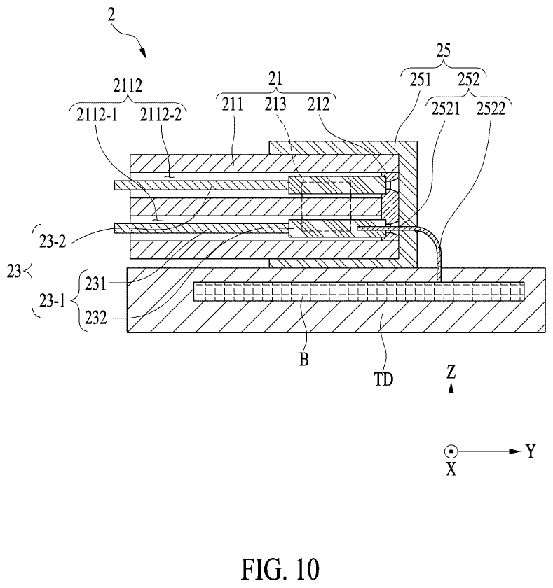

The cover body 2121 may cover an end of the plug housing 211. For example, the cover body 2121 may have a shape that covers the seating space 2113 to prevent the seating space 2113 from being exposed to the outside, based on the longitudinal direction of the terminal hole 2112. This structure may reduce a problem that a header terminal 252 (refer to FIG. 10) inserted into the terminal hole 2112 via the guide hole 2122 is damaged by being caught by the seating space 2113 or fails to be mounted on the cable terminal 232 of the cable assembly 23. In addition, the cover body 2121 may reduce a problem that the bus terminal 213 is separated from the plug housing 211 by external vibration.

The guide hole 2122 may communicate with at least some of the plurality of terminal holes 2112. Meanwhile, FIG. 5 illustrates an example of a case in which the plurality of guide holes 2122 is formed at a position corresponding to the plurality of terminal holes 2112, respectively, but the example is not limited thereto. As described below, some of the plurality of guide holes 2122 may be omitted. For example, some of the plurality of terminal holes 2112 may be closed by the cover body 2121. This structure may reduce a problem that a foreign material enters the terminal hole 2112 from the outside. For example, a cross-sectional area of a portion of the guide hole 2122 positioned on the inner surface (e.g., the surface in the −Y direction) of the plug cover 212 may be smaller than a corresponding cross-sectional area of the terminal hole 2112. This configuration may help the header terminal 252 (refer to FIG. 10) to be stably coupled to the cable terminal 232.

The hole chamfer 2123 may be formed to be inclined in a direction in which the cross-sectional area of the guide hole 2122 decreases from the outer surface (e.g., the surface in the +Y direction) of the plug cover 212 toward the inner surface (e.g., the surface in the −Y direction) of the plug cover 212. According to the hole chamfer 2123, even if the header terminal 252 (refer to FIG. 10) is not properly aligned with the guide hole 2122 or is slightly bent due to assembly tolerance, the header terminal 252 may be smoothly inserted into the guide hole 2122 along the inclined surface of the hole chamfer 2123, thus reducing an assembly defect issue and improving the convenience of coupling work.

The guide step 2124 may support an end portion (e.g., the cable terminal 232) of the cable assembly 23 inserted into the terminal hole 2112. The guide step 2124 may be positioned on the inner surface (e.g., the surface in the −Y direction) of the plug cover 212 and may have a shape extending from the guide hole 2122. For example, the guide step 2124 may have a size and shape corresponding to the size and shape of the outer perimeter of the cable terminal 232. According to this structure, as the contact arm 2132 of the bus terminal 213 is in contact with the cable terminal 232, a problem of the cable terminal 232 being pushed in a direction in which the cable terminal 232 presses may be reduced. Accordingly, the alignment accuracy of the cable terminal 232 in the terminal hole 2112 may be improved, and the contact stability between the cable terminal 232 and the contact arm 2132 may be improved.

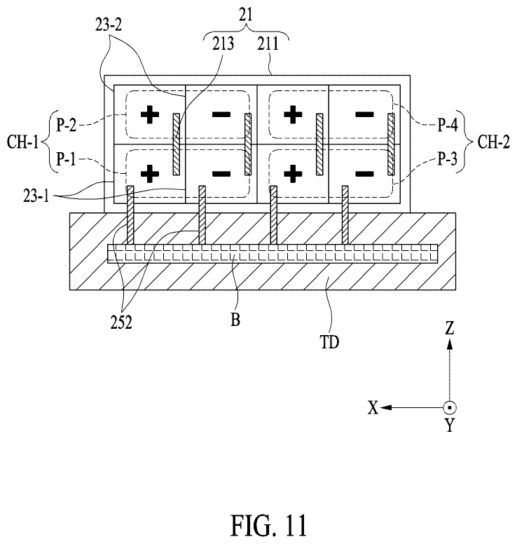

Another embodiment of a connector assembly 2 will now be described with reference to FIGS. 10-11. As shown in FIGS. 10-11, the connector assembly 2 according to an embodiment may include the plug assembly 21, the cable assembly 23, and the header assembly 25. As shown in FIG. 10, the plug assembly 21 may include the plug housing 211, the plug cover 212, and the bus terminal 213.

As shown in FIG. 10, the plug housing 211 may include a plurality of terminal holes 2112. The plurality of terminal holes 2112 may include a plurality of first terminal holes 2112-1 arranged along a first row that is parallel to the second direction (e.g., the X direction) and a plurality of second terminal holes 2112-2 arranged along a second row that is parallel to the second direction and is spaced apart from the first row in the first direction (e.g., the Z direction). For example, the number of first terminal holes 2112-1 or the number of second terminal holes 2112-2 may be an even number greater than or equal to 4, but the example is not limited thereto.

As shown in FIG. 10, the cable assembly 23 may include the cable terminal 232 and a connection cable 231 connected to the cable terminal 232. The header assembly 25 may include a header body 251 and the header terminal 252.

The header body 251, as shown in FIG. 10, may include an accommodation space which is installed in the target device TD and in which the plug assembly 21 is inserted. While the header body 251 is fixed to the target device TD, the plug assembly 21 in which the cable assembly 23 is installed may be coupled to the header body 251 to electrically connect the cable assembly 23 to the target device TD easily.

The header terminal 252 may be installed in the header body 251. As shown in FIG. 10, an end of the header terminal 252 may be connected to a circuit board B provided in the target device TD, and the other end of the header terminal 252 may be coupled to the cable terminal 232 of the cable assembly 23. The header terminal 252, as shown in FIG. 10, may include a plug connection portion 2521 coupled to the cable assembly 23 and a device connection portion 2522 coupled to the target device TD.

As shown in FIG. 11, the plug assembly 21 may include a first port P-1 including a pair of wiring structures (e.g., the terminal hole 2112 and the cable assembly 23) arranged along a first row parallel to the second direction (e.g., the X direction) and a second port P-2 including a pair of wiring structures (e.g., the terminal hole 2112 and the cable assembly 23) arranged along a second row parallel to the second direction and spaced apart from the first row in the first direction (e.g., the Z direction). The pair of cable assemblies 23 installed in the first port P-1 may be respectively connected to the pair of cable assemblies 23 provided in the second port P-2, by the bus terminal 213 to transmit the same signal. The first port P-1 and the second port P-2 may configure one first channel CH-1. Similarly, as shown in FIG. 11, a second channel CH-2 may be disposed on a side of the first channel CH-1, wherein the second channel CH-2 may include a third port P-3 aligned in parallel to the direction in which the first port P-1 is aligned and a fourth port P-4 aligned in parallel to the direction in which the second port P-2 is aligned. However the example is not limited thereto.

Meanwhile, a pair of differential signals may be transmitted to the pair of cable assemblies 23 installed in one port (e.g., the first port P-1 or the second port P-2). For example, the pair of differential signals may be transmitted via a twisted cable in which two wires are twisted. One twisted cable may be installed in one port. The differential signals may be data transmitted using two signal lines, one of which may be a first signal (e.g., a (+) signal) and the other may be a second signal (e.g., a (−) signal). The differential signals including the two signals having the same size but opposite voltages may be generated and transmitted from a transmitter (e.g., a starting node), and a receiver (e.g., an intermediate node) may receive the data based on the voltage difference between the two signals. When a transmission path of the two signals is identically configured, the influence of noise introduced between the transmitter and the receiver may equally affect the transmission path of the two signals. In addition, since the receiver receives the data based on the voltage difference between the two signals, the receiver may reconstruct a correct signal in which external noise is canceled. When there is a difference in the transmission path of the two signals configuring the differential signal, the difference between arrival times of the two signals may be caused, and the difference may be called skew. Since performance degradation may occur because of signal loss when skew occurs, configuring the transmission path of the two signals to be identical may help reduce skew occurrence.

As described above, the differential signal including the two signals may be transmitted to the circuit board B of the target device TD (e.g., the intermediate node) on which the header assembly 25 is mounted, via a pair of header terminals 252 respectively connected to a pair of first cable assemblies 23-1, as shown in FIGS. 10-11, corresponding to the first port P-1. In addition, the differential signal described above may be transmitted to a pair of second cable assemblies 23-2, as shown in FIGS. 10-11, of the second port P-2 via a pair of bus terminals 213 and may be transmitted to another target device TD (e.g., another intermediate node or an end node).

Among the plurality of cable assemblies 23, a pair of cable assemblies 23 respectively inserted into a pair of adjacent terminal holes 2112 in the first direction (e.g., the Z direction) may be electrically connected to each other via the bus terminal 213. Meanwhile, as shown in FIG. 10, the header terminal 252 may be coupled to one cable assembly 23-1 (e.g., the first cable assembly 23-1 positioned in the first row) of the pair of cable assemblies 23, and none of the plurality of header terminals 252 may be coupled to the other cable assembly 23-2 (e.g., the second cable assembly 23-2 positioned in the second row) of the pair of cable assemblies 23. As shown in FIG. 10, for example, the device connection portion 2522 of the header terminal 252 coupled to one cable assembly 23-1 (e.g., the first cable assembly 23-1) may have a shape that is bent from the plug connection portion 2521 in a direction (e.g., the −Z direction) away from the other cable assembly 23-2 (e.g., the second cable assembly 23-2).

As described above, since the second terminal hole 2112 in which the second cable assembly 23-2, to which the header terminal 252 is not connected, is inserted may not need to be open to the outside, a hole may not be formed in an area of the plug cover 212 corresponding to the second terminal hole 2112. This structure may reduce a problem that a foreign material enters the plug assembly 21 from the outside by reducing an unnecessary opening.

A first end portion of each of the plurality of header terminals 252 is arranged in parallel on a first straight line, and a second end portion of each of the plurality of header terminals 252 is arranged in parallel on a second straight line that is spaced apart from the first straight line and is parallel to the first straight line. Additionally, each of the plurality of header terminals 252 has a bent shape such that an extending direction of the first end portion of each of the plurality of header terminals 252 intersects at 90 degrees with an extending direction of the second end portion of each of the plurality of header terminals 252.

As shown in FIG. 10, among the plurality of bus terminals 213, when a pair of terminal holes 2112-1 and 2112-2 on which the first bus terminal 213 is positioned is referred to as a “first terminal hole pair”, the plurality of terminal holes 2112 may further include a “second terminal hole pair” including a pair of terminal holes 2112-1 and 2112-2 adjacent in the first direction (e.g., the +Z direction) in addition to the first terminal hole pair. For example, as shown in FIG. 10, a first pair of cable assemblies 23-1 and 23-2 respectively installed in the first terminal hole pair may be connected to a first bus terminal 213, and a second pair of cable assemblies 23-1 and 23-2 respectively installed in the second terminal hole pair may be connected to a second bus terminal 213. In this case, the length of a first header terminal 252 inserted into one terminal hole 2112-1 (e.g., a first terminal hole 2112-1) of the first terminal hole pair may be the same as the length of a second header terminal 252 inserted into one terminal hole 2112-1 (e.g., the first terminal hole 2112-1) of the second terminal hole pair. According to this structure, as described above, the lengths of the transmission paths of two signals may be the same, thereby reducing the risk of skew occurrence.

The connector assembly 2 according to an embodiment may be developed based on the premise of transmitting a differential signal. As described above, when considering the characteristic of the differential signal including the first signal (e.g., the (+) signal) and the second signal (e.g., the (−) signal), to have the same length of a path from an output end of the plug assembly 21 to the circuit board B of the target device TD, providing a port P-1, P-2, P-3 or P-4 including a pair of wiring structures may help the differential signal be correctly transmitted.

In addition, in the first terminal hole pair corresponding to the pair of first terminal holes 2112-1 configuring the first port P-1 of the first channel CH-1, a first twisted cable formed by twisting two first wires respectively transmitting the first signal and the second signal may be installed. In the second terminal hole pair corresponding to the pair of second terminal holes 2112-2 configuring the second port P-2 of the first channel CH-1, a second twisted cable formed by twisting two second wires respectively transmitting the first signal and the second signal may be installed. The first bus terminal 213 of the plurality of bus terminals 213 may transmit the first signal by connecting one of the two first wires configuring the first twisted cable to one of the two second wires configuring the second twisted cable. The second bus terminal 213 of the plurality of bus terminals 213 may transmit the second signal by connecting the other one of the two first wires to the other one of the two second wires. The pair of first terminal holes 2112-1 configuring the second terminal hole pair may be disposed adjacent in a direction (e.g., the Z direction) to the pair of second terminal holes 2112-2 configuring the first terminal hole pair, as illustrated. Through this configuration, the first signal and the second signal transmitted via the first twisted cable may pass through the first bus terminal 213 and the second bus terminal 213 and may be transmitted via the second twisted cable installed to overlap in the direction (e.g., the Z direction) described above by bypassing the target device TD.

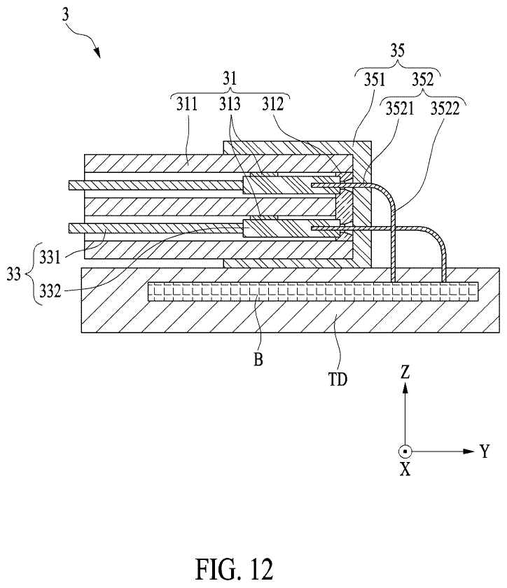

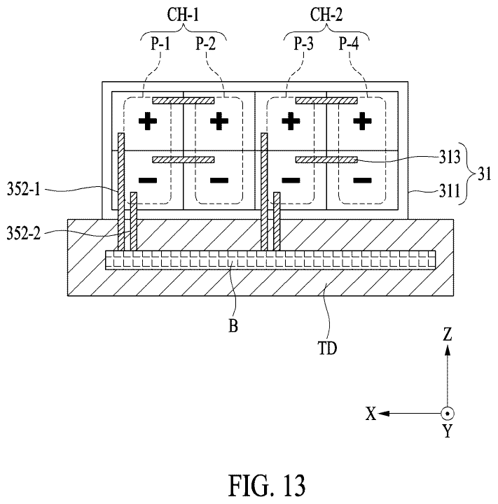

An embodiment of a connector assembly 3 will now be described with reference to FIGS. 12-13. As shown in FIG. 12, the connector assembly 3 according to an embodiment may include a plug assembly 31, a cable assembly 33, and a header assembly 35. The plug assembly 31 may include a plug housing 311, a plug cover 312, and a bus terminal 313. The cable assembly 33 may include a connecting cable 331 and a cable terminal 332. The header assembly 35 may include a header body 351 and a header terminal 352. For example, the header terminal 352 may include a plug connection portion 3521 and a device connection portion 3522.

As shown in FIG. 13, according to an embodiment, the first port P-1, the second port P-2, the third port P-3, and the fourth port P-4 may be aligned in parallel in the first direction (e.g., the Z direction). More specifically, a first signal and a second signal transmitted via a pair of twisted cables (e.g., first and second twisted cables each formed of two wires) respectively inserted into two ports (e.g., P-1 and P-2) configuring one channel (e.g., CH-1) may be transmitted in the X-axis direction via a pair of bus terminals 313. For example, a first bus terminal 313 may transmit the first signal, and a second bus terminal 313 may transmit the second signal. In this case, the pair of header terminals 352 may be formed to have different shapes so that the pair of header terminals 352 connected to one port (e.g., the first port P-1) has the same length. For example, of the pair of header terminals 352, the length of the plug connection portion 3521 of a first header terminal 352-1 may be designed to be the same as the length of the device connection portion 3522 of a second header terminal 352-2, and the length of the device connection portion 3522 of the first header terminal 352-1 may be designed to be the same as the length of the plug connection portion 3521 of the second header terminal 352-2. According to this configuration, a skew problem that occurs when a differential signal is applied to the pair of header terminals 352 may be reduced. However, according to this design, the pair of header terminals 352 may need to be spaced apart by a predetermined distance along the X-axis on the circuit board B to prevent the pair of header terminals 352 from being in contact with each other. Accordingly, a limitation may arise in that the plug housing 311 may need to be designed so that the positions of the pair of terminal holes corresponding to the first signal (e.g., the (+) signal) and the second signal (e.g., the (−) signal) are spaced apart by the distance between the pair of header terminals 352.

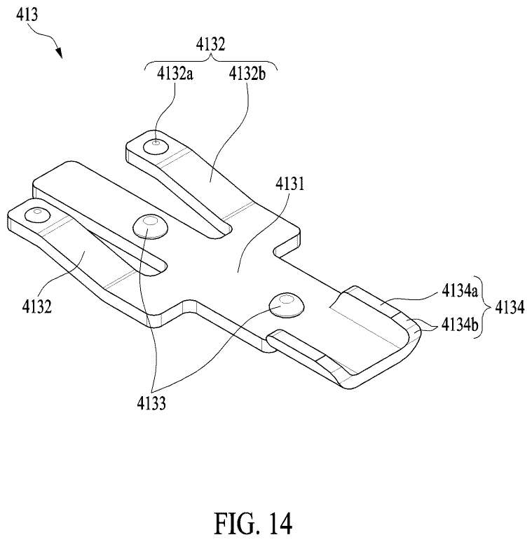

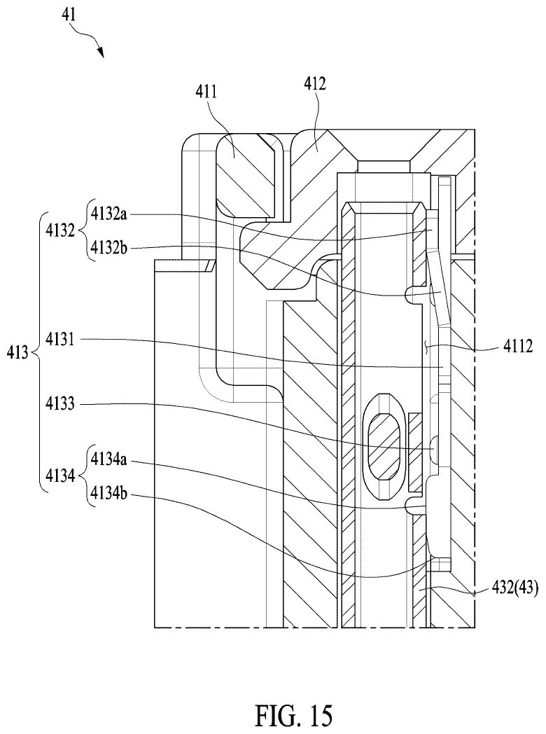

An embodiment of a plug assembly 41 will now be described with reference to FIGS. 14-15. A plug assembly 41, as shown in FIG. 14, according to an embodiment may include a plug housing 411, as shown in FIG. 14, a plug cover 412, as shown in FIG. 14, and a bus terminal 413, as shown in FIG. 14-15. As shown in FIGS. 14-15, the bus terminal 413 according to an embodiment may include a terminal body 4131, a contact arm 4132, a fixing protrusion 4133, and a contact wing 4134. The contact arm 4132 may include an arm contact portion 4132a and an arm extension 4132b.

As shown in FIG. 15, the contact wing 4134 may extend from the terminal body 4131 and may protrude to a terminal hole 4112. For example, the contact wing 4134 may be positioned on the opposite side of an end portion of the contact arm 4132 based on the center of the bus terminal 413. Since the contact wing 4134 may support a cable terminal 432 from both sides together with the contact arm 4132, as the contact arm 4132 is in contact with the cable terminal 432, a problem of the cable terminal 432 being pushed in a direction in which the cable terminal 432 presses may be reduced. Accordingly, the alignment accuracy of the cable terminal 432 in the terminal hole 4112 may be improved, and the contact stability between the cable terminal 432 and the bus terminal 413 may be improved. For example, the bus terminal 413 may include a pair of contact wings 4134 protruding into a pair of terminal holes 4112, respectively.

As shown in FIG. 14, for example, the contact wing 4134 may have a shape that is bent relative to a line parallel to the longitudinal direction of the terminal body 4131. For example, the contact wing 4134 may include a wing contact portion 4134a that may contact a cable assembly 43 (e.g., the cable terminal 432) inserted into the terminal hole 4112 and a guide portion 4134b extending from the wing contact portion 4134a.

As shown in FIG. 14, the guide portion 4134b may have a shape in which the height of the guide portion 4134b continuously decreases in a direction away from the contact arm 4132. The shape described above may reduce a problem that the cable assembly 43 may not properly enter the terminal hole 4112 because the cable assembly 43 interferes with the bus terminal 413 while inserting the cable assembly 23 into the terminal hole 4112. For example, the guide portion 4134b may have a rounded shape that is convex outwardly as illustrated, but the shape is not limited thereto.

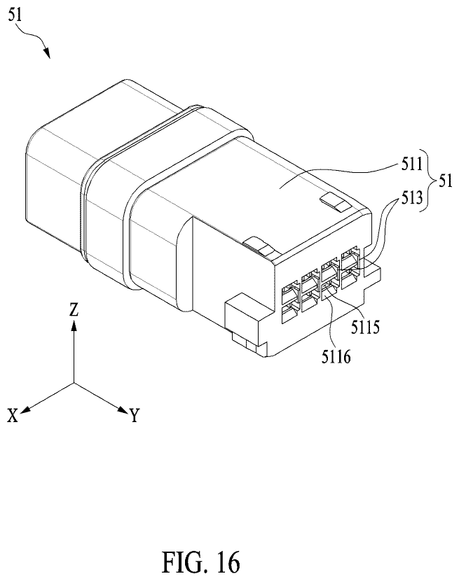

An embodiment of a plug assembly 51 will now be described with reference to FIG. 16. As shown in FIG. 16, the plug assembly 51 according to an embodiment may include a plug housing 511 and a bus terminal 513. According to an embodiment, the plug assembly 51 may not include the plug cover 212, as shown in FIG. 9, and the plug housing 511 may include a guide hole 5115 and a hole chamfer 5116. Unless otherwise disclosed, the description of the hole chamfer 2123 and the guide hole 2122 of the plug cover 212 of FIG. 9 may apply to the hole chamfer 5116 and the guide hole 5115 of the plug housing 511. According to this configuration, since there is no need to form a plug cover, the manufacturing cost of a product may be saved. Meanwhile, to assist in proper assembly, at an end portion of the guide hole 5115, the hole chamfer 2123 may need to be formed on three surfaces other than the surface in which the bus terminal 513 is inserted, and an additional fixing structure to prevent the bus terminal 513 from being separated from the plug housing 511 by external vibration may need to be provided.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A plug assembly, comprising:
a plug housing including a plug body having a plurality of first direction partition walls longitudinally formed in a first direction, a plurality of second direction partition walls formed in a second direction that intersects with the first direction, a plurality of terminal holes defined by the plurality of first direction partition walls and the plurality of second direction partition walls, and a seating space allowing a pair of terminal holes of the plurality of terminal holes that are adjacent in the first direction to communicate with each other; and
a bus terminal including a terminal body inserted into the seating space and a pair of contact arms extending from the terminal body and each protruding into one of the pair of terminal holes, the plug assembly is inserted into a header assembly of a target device.

2. The plug assembly of claim 1, wherein the bus terminal has a fixing protrusion protruding from the terminal body, the fixing protrusion is fixed to one second direction partition wall positioned between the pair of terminal holes.

3. The plug assembly of claim 1, wherein the bus terminal has a pair of contact wings extending from the terminal body and respectively protruding into the pair of terminal holes.

4. The plug assembly of claim 3, wherein the pair of contact wings are respectively positioned on an opposite side of end portions of the pair of contact arms.

5. The plug assembly of claim 3, wherein at least one of the pair of contact wings includes a wing contact portion and a guide portion extending from the wing contact portion, the wing contact portion is in contact with a cable assembly inserted into one of the plurality of terminal holes, the guide portion has a shape in which a height of the guide portion continuously decreases in a direction away from the pair of contact arms.

6. The plug assembly of claim 1, wherein the plug assembly further comprises a plug cover, the plug cover has a cover body covering an end of the plug housing and a plurality of guide holes communicating with at least some of the plurality of terminal holes.

7. The plug assembly of claim 6, wherein a plurality of cross-sectional areas of portions of the plurality of guide holes positioned on an inner surface of the plug cover are each smaller than a plurality of cross-sectional areas of the corresponding plurality of terminal holes, and the plug cover has a plurality of hole chamfers formed to be inclined in a direction in which a cross-sectional area of each of the plurality of guide holes decreases from an outer surface of the plug cover toward an inner surface of the plug cover.

8. The plug assembly of claim 6, wherein the plug cover has a shape that covers the seating space such that the seating space is not exposed to an outside.

9. The plug assembly of claim 6, wherein the plug cover has a guide step supporting an end portion of a cable assembly inserted into one of the plurality of terminal holes, the guide step is positioned on an inner surface of the plug cover and has a shape extending from the plurality of guide holes.

10. The plug assembly of claim 1, wherein the plurality of terminal holes include a plurality of first terminal holes and a plurality of second terminal holes, the plurality of first terminal holes are arranged along a first row parallel to the second direction, the plurality of second terminal holes are arranged along a second row that is parallel to the second direction and is spaced apart from the first row in the first direction, the plug assembly has a plurality of bus terminals, each bus terminal is installed between one of the plurality of first terminal holes and one of the plurality of second terminal holes.

11. A connector assembly comprising:
a plug assembly including a plug housing and a bus terminal, the plug housing includes a plug body having a plurality of first direction partition walls longitudinally formed in a first direction, a plurality of second direction partition walls formed in a second direction that intersects with the first direction, a plurality of terminal holes defined by the plurality of first direction partition walls and the plurality of second direction partition walls, and a seating space allowing a pair of terminal holes of the plurality of terminal holes that are adjacent in the first direction to communicate with each other, the bus terminal includes a terminal body inserted into the seating space and a pair of contact arms extending from the terminal body and each protruding into one of the pair of terminal holes;
a plurality of cable assemblies including a plurality of cable terminals respectively inserted into the plurality of terminal holes and a plurality of connecting cables respectively connected to the plurality of cable terminals; and
a header assembly including a header body having an accommodation space in which the plug assembly is inserted and a plurality of header terminals installed in the header body and coupled to at least some of the plurality of cable terminals.

12. The connector assembly of claim 11, wherein a pair of cable assemblies of the plurality of cable assemblies inserted into the pair of terminal holes is electrically connected to each other by the bus terminal, one of the plurality of header terminals is coupled to one of the pair of cable assemblies, and none of the plurality of header terminals are coupled to the other one of the pair of cable assemblies.

13. The connector assembly of claim 12, wherein the plug assembly includes a plug cover having a cover body covering an end of the plug housing and a plurality of guide holes communicating with at least some of the plurality of terminal holes, in the cover body, a hole is not formed in an area corresponding to one of the plurality of terminal holes in which the other one of the pair of cable assemblies is inserted.

14. The connector assembly of claim 12, wherein the header terminal includes a plug connection portion and a device connection portion, the plug connection portion is coupled to one of the plurality of cable assemblies, the device connection portion is coupled to a target device on which the header assembly is mounted, and the device connection portion has a shape that is bent from the plug connection portion in a direction away from the other one of the pair of cable assemblies.

15. The connector assembly of claim 11, wherein the pair of terminal holes is a first terminal hole pair, the plurality of terminal holes has a second terminal hole pair including a pair of adjacent terminal holes in the first direction, the bus terminal is a first bus terminal, the plug assembly further comprises a second bus terminal corresponding to the second terminal hole pair, a length of a first header terminal inserted into one terminal hole of the first terminal hole pair is equal to a length of a second header terminal inserted into one terminal hole of the second terminal hole pair.

16. The connector assembly of claim 15, wherein a pair of differential signals are respectively applied to a target device on which the header assembly is mounted via the first header terminal and the second header terminal.

17. The connector assembly of claim 11, wherein the plurality of connecting cables includes a first twisted cable and a second twisted cable, and the plurality of terminal holes includes a first terminal hole pair and a second terminal hole pair, the first twisted cable is formed by twisting two first wires respectively transmitting a first signal and a second signal, the second twisted cable is formed by twisting two second wires respectively receiving the first signal and the second signal from the first twisted cable and transmitting the first signal and the second signal, the first terminal hole pair consists of a first pair of terminal holes in which the two first wires are inserted, respectively, and the second terminal hole pair consists of a second pair of terminal holes in which the two second wires are inserted and which is positioned adjacent to the first pair of terminal holes, respectively, the bus terminal is a first bus terminal and the plug assembly further comprises a second bus terminal, the first bus terminal transmits the first signal by connecting one of the two first wires to one of the two second wires, the second bus terminal transmits the second signal by connecting another one of the two first wires to another one of the two second wires, the plurality of header terminals is connected to one of the first twisted cable or the second twisted cable and is not connected to the other twisted cable.

18. The connector assembly of claim 17, wherein a plurality of lengths of the plurality of header terminals are equal to each other.

19. The connector assembly of claim 18, wherein a first end portion of each of the plurality of header terminals is arranged in parallel on a first straight line, and a second end portion of each of the plurality of header terminals is arranged in parallel on a second straight line that is spaced apart from the first straight line and is parallel to the first straight line.

20. The connector assembly of claim 19, wherein each of the plurality of header terminals has a bent shape such that an extending direction of the first end portion of each of the plurality of header terminals intersects at 90 degrees with an extending direction of the second end portion of each of the plurality of header terminals.
